(19) United States
(12) Patent Application Publication
(10) Pub. No.: US 2015/0263663 A1
(43) Pub. Date: Sep. 17, 2015

(54) Light-Harvesting Power Supply With Power Management and Load Identification Capability

(71) Applicant: Rock-Tenn Shared Services, LLC, Norcross, GA (US)

(72) Inventors: Philip Lazo, Mt. Airy, MD (US); David Rankin, Winston Salem, NC (US); Kien Lao, Durham, NC (US); Thomas A. Lockwood, Clemmons, NC (US)

(21) Appl. No.: 14/642,339

(22) Filed: Mar. 9, 2015

Related U.S. Application Data
(60) Provisional application No. 61/951,441, filed on Mar. 11, 2014.

(51) Int. Cl. H01L 31/04; G05B 15/02

(52) U.S. Cl. CPC H02S 10/00; G05B 15/02

(57) ABSTRACT

A light-harvesting power supply system is provided that can perform one or more of power management and load identification. The power supply system can include a power harvesting unit and a controller. The power harvesting unit can convert light energy into electrical energy that may be provided to one or more load devices via one or more terminals of the power supply system. In some aspects, the controller can allocate electrical energy among load devices based on their respective power requirements and an available amount of electrical energy from the power harvesting unit. The controller can cause the electrical energy to be provided to the load devices based on the allocation of available energy. In additional or alternative aspects, the power supply system can determine that a device is not authorized to receive power. The controller can prevent the power harvesting unit from providing electrical energy to the unauthorized device.

### CROSS-REFERENCE TO RELATED APPLICATION

This disclosure claims priority to U.S. Provisional Application Ser. No. 61/951,441, filed on Mar. 11, 2014 and titled “Light Harvesting Power Supply with Power Management and Load Identification Capability,” the contents of which are incorporated herein by reference.

### TECHNICAL FIELD

The present disclosure relates generally to powering electrical devices and more particularly (although not necessarily exclusively) to a light-harvesting power supply for point-of-purchase displays and other in-store displays that can perform power management and load identification functions.

### BACKGROUND

Point-of-purchase displays and other in-store displays require a source of electrical power. In some locations within a store, power outlets for accessing an AC power source may be unavailable. Although batteries may be used to provide power to an in-store display in such locations, the use of batteries may present disadvantages (e.g., requirement of replacing batteries, unexpected loss of power when batteries are drained, etc.).

It is desirable to provide improved systems and methods for powering point-of-purchase displays and other in-store displays.

### SUMMARY

In some aspects, a light-harvesting power supply system is provided that can perform power management functions. The power supply system can include a power harvesting unit and a controller. The power harvesting unit can convert light energy into electrical energy. The power supply system can provide the generated electrical energy to one or more load devices via one or more terminals of the power supply system. In some aspects, the controller can allocate electrical energy among load devices based on their respective power requirements and an amount of electrical energy that is available from the power harvesting unit. The controller can cause the electrical energy to be provided to the load devices based on the determined allocation of available energy.

In additional or alternative aspects, a light-harvesting power supply system is provided that can perform load identification and thereby prevent unauthorized devices from drawing power from the power supply system. The power supply system can include a power harvesting unit and a controller. The power harvesting unit can convert light energy into electrical energy that may be provided to one or more load devices via one or more terminals of the power supply system. The power supply system can determine that a device that is receiving electrical energy via one of the terminals is not authorized to do so. The controller can prevent the power harvesting unit from providing the electrical energy to the unauthorized device via the terminal.

These illustrative aspects and features are mentioned not to limit or define the disclosure, but to provide examples to aid understanding of the concepts disclosed in this application. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. Other aspects, advantages, and features of the present disclosure will become apparent after review of the entire application. The subject matter should be understood by reference to appropriate portions of the entire specification of this disclosure, any or all drawings, and each claim.

### BRIEF DESCRIPTION OF THE DRAWINGS

FIG. 1 is a block diagram depicting an example of a power supply that manages the distribution of power generated from harvested light energy according to one aspect of the present disclosure.

FIG. 2 is a block diagram depicting an example of a power harvesting unit of the power supply of FIG. 1 according to one aspect of the present disclosure.

FIG. 3 is a block diagram depicting an example of a controller of the power supply of FIG. 1 according to one aspect of the present disclosure.

FIG. 4 is a flow chart depicting an example of a method for allocating the distribution of electrical energy generated by a power harvesting unit among load devices according to one aspect of the present disclosure.

FIG. 5 is a flow chart depicting an example of a method for preventing electrical energy generated by a power harvesting unit from being provided to an unauthorized load device according to one aspect of the present disclosure.

### DETAILED DESCRIPTION

Certain aspects and features of the present invention are directed to a light-harvesting power supply for point-of-purchase displays and other in-store displays that can perform power management and load identification functions. The light-harvesting power supply system can generate electrical energy from artificial light other than solar energy (e.g., illumination provided by indoor lighting systems). The light-harvesting power supply system can store the generated energy and provide the stored energy to one or more load devices. Examples of load devices include (but are not limited to) lighting devices, sound emitters, motorized components, and/or other devices that may be included in an in-store display or other system that is powered using the power supply system.

The light-harvesting power supply system can perform power management functions that determine an allocation of the available amount of generated electrical energy. The light-harvesting power supply system can provide the generated amount of electrical energy to load devices in accordance with the determined allocation. Additionally or alternatively, the light-harvesting power supply system can also determine whether one or more unauthorized load devices are receiving at least some of the generated electrical energy. The power supply system can perform remedial actions that prevent the unauthorized load device from doing so (e.g., by disconnecting power to a terminal connected to the unauthorized device).

One or more of these power management and load identification functions can allow a movable in-store display or other system to use harvested indoor light as a power source. For example, an in-store display or other system may be positioned in an area in which access to power outlets is unavailable or infeasible (e.g., where using extension cords to connect the display would present safety hazards). Using a power harvesting unit can allow the in-store display or other system to be powered without using a power outlet, thereby increasing the number of places in which the in-store display or other system can be positioned.

The electrical energy generated by a power harvesting unit may be less than the amount of electrical energy that is available using a power outlet. Using power management functions can improve the efficiency with which this limited amount of electrical energy is provided to load devices (e.g., lighting devices, sound emitters, motorized components) that may be included in an in-store display or other system. Using load identification functions can prevent this limited amount of electrical energy from being depleted by unauthorized devices to the detriment of the intended load devices (e.g., the components of the in-store display).

The subject matter of the present invention is described here with specificity to meet statutory requirements, but this description is not necessarily intended to limit the scope of the claims. Detailed descriptions of certain examples are discussed below. These illustrative examples are given to introduce the reader to the general subject matter discussed here and are not intended to limit the scope of the disclosed concepts. The following sections describe various additional aspects and examples with reference to the drawings in which like numerals indicate like elements, and directional descriptions are used to describe the illustrative examples but, like the illustrative examples, should not be used to limit the present disclosure. The various figures described below depict examples of implementations for the present disclosure, but should not be used to limit the present disclosure.

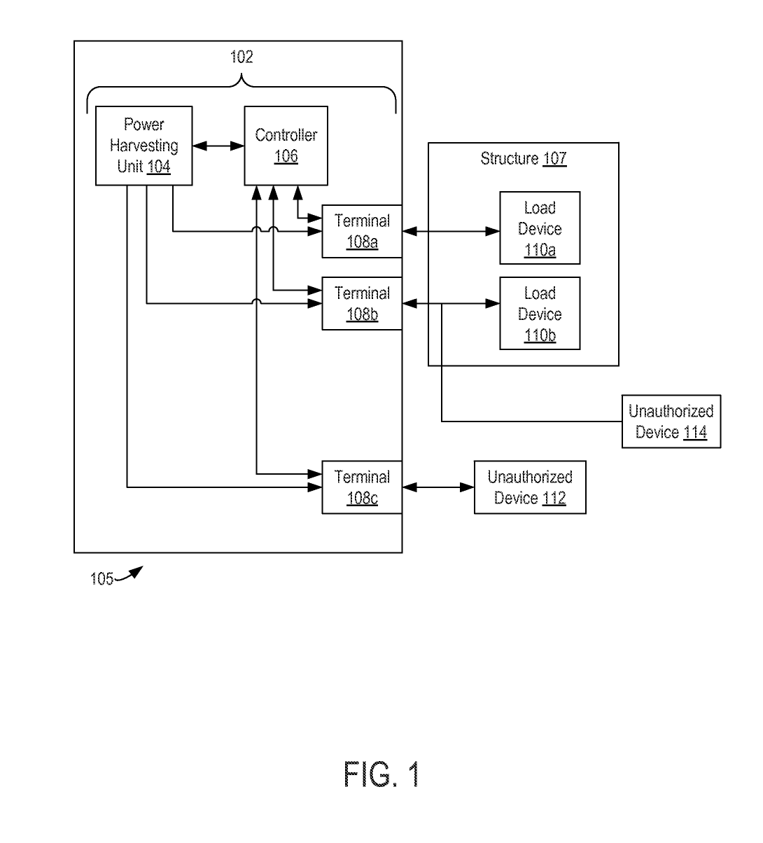

Referring now to the drawings, FIG. 1 is a block diagram depicting an example of a power supply system 102 for managing the distribution of power generated from harvested light energy according to one aspect of the present disclosure. The power supply system 102 can include a power harvesting unit 104, a controller 106, and one or more terminals 108a-c.

The power supply system 102 can be used to power one or more load devices 110a, 110b. In some aspects, the load devices 110a, 110b can include powered electronics used for point-of-purchase displays and in-store interactive experiences integrated with the point-of-purchase display. Examples of such load devices 110a, 110b include (but are not limited to) lighting sources, motors, electronic inks, etc.

The power harvesting unit 104 can harvest light energy generated by indoor lighting systems. The power harvesting unit 104 can store electrical power generated from the harvested light energy. An example of a power harvesting unit 104 is a device that includes one or more power harvesting panels.

The power harvesting unit 104 depicted in FIG. 1 is electrically coupled to terminals 108a-c. The power harvesting unit 104 can provide power to one or more of the load devices 110a, 110b via one or more of the terminals 108a-c. (Although FIG. 1 depicts three terminals 108a-c for illustrative purposes, a power supply system 102 can include any number of terminals, including one.) Each of the terminals 108a-c can be electrically coupled to a load device. In some aspects, conductors in the terminals 108a-c can be physically connected to wires or other conductors that are electrically coupled to the load devices. In other aspects, one or more of the terminals 108a-c can be electrically coupled to the load devices 110a, 110b in an inductive manner.

The controller 106 depicted in FIG. 1 is communicatively coupled and/or electrically coupled to the power harvesting unit 104 and the terminals 108a-c. The communicative and/or electrical coupling can be implemented in any suitable manner. For example, the controller 106 can be communicatively coupled and/or electrically coupled to the power harvesting unit 104 and the terminals 108a-c via a printed circuit board included in the power supply system 102.

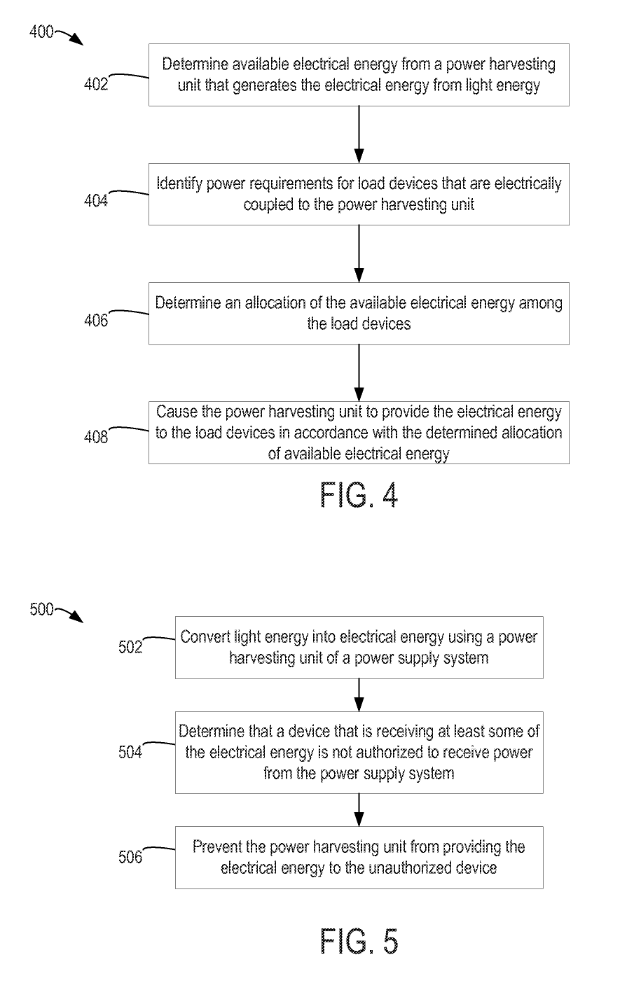

In some aspects, the controller 106 can manage the distribution of electrical energy from the power harvesting unit 104 to load devices via the terminals 108a-c. Examples of this power management function are described in detail with respect to FIG. 4 below.

In additional or alternative aspects, the controller 106 can prevent the distribution of electrical energy from the power harvesting unit 104 to unauthorized load devices or non-compliant devices. In some aspects, an unauthorized device 112 can be electrically coupled to a terminal 108c that is not in use by another load device. In additional or alternative aspects, an unauthorized device 114 can draw power via a tap that is added to a wire or other electrical coupling between one of the load devices 110a, 110b and one of the terminals 108a, 108b. The tap can be used to share power that is obtained from the electrical coupling. The power can be shared between the authorized load device 110b and the unauthorized device 114. Examples of preventing the distribution of power to unauthorized devices are described in detail with respect to FIG. 5 below.

A housing 105 or other suitable structure can contain the power supply system 102. In some aspects, the housing 105 can be used to connect the power supply system 102 to a structure 107, as depicted in FIG. 1. An example of a structure 107 is an in-store retail display on which one or more load devices 110a, 110b (e.g., illumination devices) are positioned. In other aspects, the housing 105 that contains the power supply system 102 may not be connected or otherwise coupled to the structure 107. One or more load devices 110a, 110b can be electrically coupled to one or more of the terminals 108a, 108b using one or more electrical cables or other suitable conductors.

For illustrative purposes, FIG. 1 depicts a single structure 107 in which two load devices 110a, 110b are disposed. However, any number of load devices can be used with the power supply system 102 and can be included in or positioned on any number of structures. For example, two different structures, each of which includes a respective load device connected to one of the terminals 108a-c, can be used with the power supply system 102.

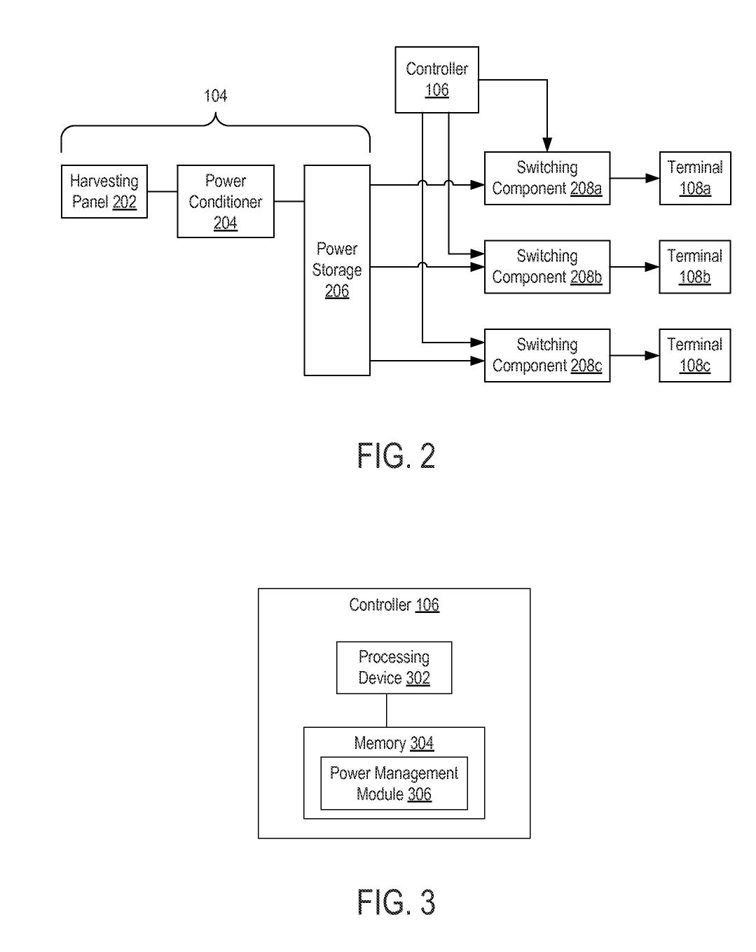

FIG. 2 is a block diagram depicting an example of a power harvesting unit 104 of the power supply system 102. The power harvesting unit 104 can include a power harvesting panel 202, a power conditioner 204, and a power storage device 206. The example depicted in FIG. 2 is provided for illustrative purposes. Other implementations of the power harvesting unit 104 are possible.

The power harvesting panel 202 can include one or more devices or other components that are used to convert light energy into electrical energy. In some aspects, the power harvesting panel 202 can include one or more photovoltaic cells or other light harvesting devices that are tuned, adapted, or otherwise configured for harvesting light that is available in indoor environments. The power harvesting panel 202 can generate electrical power from the harvested light. An example of a power harvesting panel 202 is a panel including one or more dye-sensitized photo-electric cells. In additional or alternative aspects, the power harvesting panel 202 can include one or more photovoltaic cells using other suitable materials, such as (but not limited to) amorphous silicon and/or crystalline silicon. In additional or alternative aspects, the power harvesting panel 202 can include one or more power additional harvesting devices that use other means for harvesting power (e.g., by harvesting mechanical energy, such as a vibration, or thermal energy).

The power conditioner 204 can include one or more devices or components that are used to improve the quality of power that is provided from the power harvesting unit 104 to the load devices 110a, 110b. An example of a power conditioner 204 is a DC-to-DC power conditioner.

The power storage device 206 can include one or more devices or components that are used to store electrical energy that is generated by the power harvesting unit 104 from light energy. Non-limiting examples of a power storage device 206 include a battery, a super-capacitor, or any other suitable device for storing energy.

The power supply system 102 can include switching components 208a-c that are positioned in respective electrical paths from the power harvesting unit 104 and the terminals 108a-c. Examples of the switching components 208a-c include transistors, relays, or other suitable components that can selectively couple the power harvesting unit 104 to the terminals 108a-c. For example, in aspects in which the switching components 208a-c include transistors, the controller 106 can cause an electrical current or voltage to be provided to a base or gate of a transistor to allow current to flow through the transistor. In aspects in which the switching components 208a-c include relays, the controller 106 can cause an electrical current to be provided to an actuation coil of a relay that allows a relay to open or close, thereby connecting or disconnecting a terminal to an electrical path that includes the relay.

For illustrative purposes, FIG. 2 depicts switching components 208a-c that are separate from the controller 106 and the power harvesting unit 104. FIG. 2 also depicts the switching components 208a-c as being positioned between the power storage device 206 and the terminals 108a-c. However, other implementations are possible. Any suitable implementation can be used that allows the controller 106 to selectively allow or prevent the provision of electrical energy generated by the power harvesting unit 104 to load devices that are electrically coupled to one or more of the terminals 108a-c. In some aspects, the switching components 208a-c can be included in the power harvesting unit 104. In additional or alternative aspects, the controller 106 may include the switching components 208a-c that are positioned in one or more electrical paths from the power harvesting unit 104. In additional or alternative aspects, the switching components 208a-c can be positioned in one or more electrical paths from one or more components of the power harvesting unit 104 in addition to or other than the power storage device 206 depicted in FIG. 2.

The controller 106 can be implemented in any suitable manner. For example, FIG. 3 is a block diagram depicting an example of a controller 106. The controller 106 can include one or more processing devices 302 and one or more memory devices 304. The memory devices 304 can be included in or communicatively coupled to the processing device 302.

The processing device 302 can include any device or group of devices that are capable of executing program code to perform the operations described herein. Examples of the processing device 302 include a microprocessor, an application-specific integrated circuit (“ASIC”), a field-programmable gate array (“FPGA”), or other suitable processor. The processing device 302 may include one processor or any number of processors.

The memory device 304 can store program code that, when executed by the processing device 302, causes the processing device 302 to perform operations described herein. The memory device 304 may include one or more non-transitory computer-readable media such as (but not limited to) an electronic, optical, magnetic, or other storage device capable of providing a processor with computer-readable instructions. Non-limiting examples of such optical, magnetic, or other storage devices include read-only (“ROM”) memory device(s), random-access memory (“RAM”) device(s), magnetic disk(s), magnetic tape(s) or other magnetic storage, memory chip(s), an ASIC, configured processor(s), optical storage device(s), or any other medium from which a computer processor can read instructions. The program code may include processor-specific instructions generated by a compiler and/or an interpreter from code written in any suitable computer-programming language. Non-limiting examples of suitable computer-programming languages include C, C++, C#, Visual Basic, Java, Python, Perl, JavaScript, ActionScript, and the like.

An example of program code that is stored in the memory device 304 is a power management module 306. In some aspects, the power management module 306 can configure the processing device 302 to perform one or more power management processes. In additional or alternative aspects, the power management module 306 can configure the processing device 302 to perform one or more processes for preventing unauthorized devices from being powered by the power supply system 102.

Power management can include allocating electrical energy among the load devices 110a, 110b. For example, FIG. 4 is a flow chart depicting an example of a method 400 for allocating the distribution of electrical energy generated by a power harvesting unit among load devices. For illustrative purposes, the method 400 is described with reference to the implementation depicted in FIGS. 1-3. Other implementations, however, are possible.

The method 400 involves determining an amount of electrical energy that is available from a power harvesting unit 104 that generates the electrical energy from light energy, as depicted in block 402. For example, the processing device 302 can execute a power management module 306 or other suitable program code stored in a memory device 304. Executing the power management module 306 or other suitable program code can configure the processing device 302 to perform one or more operations that involve determining the available electrical energy from the power harvesting unit 104. Examples of an available amount of electrical energy include (but are not limited to) an amount of power stored by a power storage device 206 of the power harvesting unit 104, an amount of light energy available for harvesting in an environment in which the power supply system 102 is deployed, etc.

In some aspects, the controller 106 can determine the available electrical energy from the power harvesting unit 104 using one or more light sensors. For example, the available electrical energy may be limited by an amount of light in an environment in which the power supply system 102 is deployed. The controller 106 can use the power harvesting unit 104 to obtain data that describes this amount of light.

In some aspects, an input of the processing device 302 can be coupled to the power harvesting panel 202, the power conditioner 204, or another component of the power harvesting unit 104. The input can receive a voltage or current from the power harvesting unit 104 that is indicative of the amount of light received by the power harvesting panel 202 or another light-sensing component of the power harvesting unit 104 (e.g., a dedicated light sensor separate from the power harvesting panel 202). The processing device 302 can sample the voltage or current to determine an amount of light detected by the power harvesting unit 104.

In additional or alternative aspects, the power harvesting 104 unit may include processing circuitry that can receive a sampled current or voltage from the power harvesting panel 202 or another light-sensing component of the power harvesting unit 104 (e.g., a dedicated light sensor separate from the power harvesting panel 202). The processing circuitry can generate data indicative of the amount of light in an environment in which the power supply system 102 is deployed. The processing circuitry of the power harvesting unit 104 can transmit the data to the processing device 302.

The method 400 also involves identifying power requirements for load devices 110a, 110b that are electrically coupled to the power harvesting unit 104, as depicted in block 404. For example, the processing device 302 can execute a power management module 306 or other suitable program code stored in a memory device 304. Executing the power management module 306 or other suitable program code can configure the processing device 302 to perform one or more operations that involve identifying the power requirements for one or more load devices 110a, 110b.

In some aspects, the controller 106 can identify or otherwise determine power requirements for the load devices 110a, 110b using performance specifications for each of the load devices 110a, 110b. Non-limiting examples of such performance specifications include time periods in which power is to be provided to one or more of the load devices 110a, 110b (e.g., during the operating hours of a business in which the structure 107 is positioned), respective duty cycles for the load devices 110a, 110b (e.g., a number of times during a given time period in which a load device is activated), etc. For example, the load devices 110a, 110b may be included in different in-store displays for different marketing campaigns. The controller 106 can receive one or more performance specifications for each of the load devices 110a, 110b that correspond to the different marketing campaigns.

The performance specifications can be provided to the controller 106 in any suitable manner. In some aspects, one or more of the load devices 110a, 110b can include a memory device for storing one or more performance specifications. One or more of the load devices 110a, 110b can establish a communication link with the controller 106. The controller 106 can receive one or more performance specifications from the load device via the communication link. One example of a communication link is a link established via one of the terminals 108a-c. For example, one or more of the terminals 108a-c can include at least one conductor that is used to provide power to a load device and at least one additional conductor that is used to communicate data signals with the load device. Additionally or alternatively, an electrical current that is provided from the power supply system 102 to a load device via the terminal and that is used to power the load device can be modulated with data to be provided to the load device. A return current that is received by the power supply system 102 from the load device via the terminal can be modulated with data that is to be provided to the controller 106 from the load device. Another example of a communication link is a link established via a first wireless transceiver or other transceiver of the power supply system 102 and a second wireless transceiver or other transceiver of a load device. Such a communication link may not require a coupling via one of the terminals 108a-c.

In other aspects, a device separate from the load devices 110a, 110b can establish a communication link with the controller 106 via one of the terminals 108a-c or some other communication terminal. The separate device can provide device identifiers for the load devices 110a, 110b and performance specifications associated with the device identifiers to the controller 106 via the communication link. The controller 106 can identify power requirements for the load devices 110a, 110b based on determining that the load devices 110a, 110b coupled to the terminals 108a, 108b have the device identifiers.

In additional or alternative aspects, the performance specifications for one or more of the load devices 110a, 110b can specify different schemes for providing power to the load devices 110a, 110b based on an amount of light detected in the environment in which the power supply system 102 is deployed. For example, each of the load devices 110a, 110b may be illumination devices. The controller 106 may receive data from the power harvesting unit 104 that indicates an amount of light in the environment. The data may be generated based on light detected by photovoltaic cells or other light harvesting devices in the power harvesting unit 104. During a first time period, the controller 106 may determine that a first amount of light is detected in the environment (e.g., 800 lux). The performance specification may specify that if the amount of detected light is below a threshold (e.g., 900 lux), the controller 106 is to select a duty cycle for the load devices 110a, 110b in which each of the load devices 110a, 110b is constantly illuminated during the first time period. The constant illumination may be sufficiently effective in attracting attention in environments with lower illumination. During a second time period, the controller 106 may determine that a second amount of light is detected in the environment (e.g., 1200 lux). The performance specification may specify that if the amount of detected light is above a threshold (e.g., 900 lux), the controller 106 is to select a duty cycle for the load devices 110a, 110b in which the load devices 110a, 110b are illuminated in a blinking sequence or a sequence mimicking motion during the second time period. The blinking sequence may be more effective in attracting attention in environments with higher illumination.

The method 400 also involves determining an allocation of the available electrical energy among the load devices 110a, 110b, as depicted in block 406. For example, the processing device 302 can execute a power management module 306 or other suitable program code stored in a memory device 304. Executing the power management module 306 or other suitable program code can configure the processing device 302 to perform one or more operations that involve determining the allocation of the available electrical energy among the load devices 110a, 110b.

In some aspects, the controller 106 can determine an allocation of the available electrical energy among the load devices 110a, 110b such that electrical energy is transferred to the load devices 110a, 110b in an efficient manner. For example, the controller 106 can monitor the maximum power transfer point of the power harvesting unit 104. The controller 106 determines an allocation of the available electrical energy based on the maximum power transfer point such that electrical energy is transferred to the load devices 110a, 110b in an efficient manner.

In additional or alternative aspects, the controller 106 can determine an allocation of the available electrical energy among the load devices 110a, 110b based on monitoring an amount of energy stored by the power harvesting unit 104. For example, the controller 106 can receive or otherwise obtain data indicating an amount of electrical energy stored in the power storage device 206 depicted in FIG. 2. The controller 106 can modify load characteristics based on the amount of stored energy. Examples of load characteristics include (but are not limited to) functions performed by the load devices 110a, 110b that affect the amount of power consumed by the load devices 110a, 110b, such as duty cycles, lighting characteristics, etc. The controller 106 can modify load characteristics such that a balance is maintained among the power requirements of the load devices 110a, 110b, the available electrical energy stored by the power harvesting unit 104, and the performance specifications of the load devices 110a, 110b (e.g., business or operational goals of an in-store display that includes the load devices 110a, 110b).

In some aspects, the controller 106 can allocate the available electrical energy proportionately among the load devices 110a, 110b. For example, the controller 106 can determine a combined power requirement of the load devices 110a, 110b. The controller 106 can allocate a first portion of the available electrical energy to the load device 110a and a second portion of the available electrical energy to the load device 110b. The first allocated energy portion can be proportionate to the contribution of a power requirement of the load device 110a to the combined power requirement. The second allocated energy portion can be proportionate to the contribution of a power requirement of the load device 110b to the combined power requirement.

In additional or alternative aspects, the controller 106 can be used to prioritize the allocation of power to different load devices. The allocation of power can be prioritized based on the performance specifications or other power requirements of the load devices 110a, 110b.

In additional or alternative aspects, the controller 106 can determine an allocation of the available electrical energy among the load devices 110a, 110b such that the load devices 110a, 110b can perform a minimum number of required operations. For example, the controller 106 can determine, identify, select, or otherwise set a minimum number of activations for each of the load devices 110a, 110b. An activation of a load device can include, for example, an amount of time during which electrical energy is provided to a lighting device or other load device that emits an output detected by a shopper (e.g., a sound, a vibration, etc.). In some aspects, different minimum numbers of activations can be used for different load devices 110a, 110b. The controller 106 can allocate the electrical energy such that the minimum number of activations for each of the load devices 110a, 110b is performed. In additional or alternative aspects, the controller 106 can identify a remaining portion of electrical energy that is available for allocation after a first portion of electrical energy is allocated for the minimum number of activations for each of the load devices 110a, 110b. The controller 106 can allocate the remaining portion of the electrical energy based on respective priorities associated with the load devices 110a, 110b. The controller 106 can determine or otherwise identify respective priorities associated with the load devices 110a, 110b using the performance specifications for the load devices 110a, 110b that are obtained by the controller 106 in the manner described above.

In additional or alternative aspects, the controller 106 can determine an allocation of the available electrical energy among the load devices 110a, 110b based on one or more characteristics of an environment in which the power supply system 102 is deployed. For example, the controller 106 may determine the operating hours of a store in which a display that includes the load devices 110a, 110b is positioned. The controller 106 can configure the terminals 108a-c of the power supply system 102 such that electrical energy provided to the load devices 110a, 110b during at least some of the operating hours. The controller 106 can configure the terminals 108a-c of the power supply system 102 such that electrical energy provided to the load devices 110a, 110b is reduced or is not provided to the load devices 110a, 110b during a time period that is outside the operating hours.

In additional or alternative aspects, the controller 106 can determine an allocation of the available electrical energy among the load devices 110a, 110b based on requests for electrical energy received from one or more of the load devices 110a, 110b. For example, one or more authorized load devices 110a, 110b can transmit a request for electrical energy to the controller 106 at specified intervals. This information is used in combination with information about the power requirements of other attached devices to enable smart energy scheduling by the controller 106. For example, if the amount of requested energy is not available, the controller 106 can transmit a message to the requesting load device indicating that the request has been denied. The load device can transmit an additional request to the controller 106 for a lower level of energy. The lower level of energy can be less than the first amount of request energy and can provide an acceptable level of functionality for the load device. The controller 106 can accept or reject the additional request based on the available energy from the power harvesting unit 104. If the additional request is approved, the load device can operate at a level of functionality that utilizes the lower amount of power. If the additional request is denied, the load device can suspend operations until conditions improve (e.g., additional power is available).

The method 400 also involves causing the power harvesting unit 104 to provide the electrical energy to the load devices 110a, 110b in accordance with the determined allocation of available electrical energy, as depicted in block 408. For example, the processing device 302 can execute a power management module 306 or other suitable program code stored in a memory device 304. Executing the power management module 306 or other suitable program code can configure the processing device 302 to perform one or more operations that involve causing the power harvesting unit 104 to provide the electrical energy to the load devices 110a, 110b in accordance with the determined allocation of available electrical energy.

In some aspects, the controller 106 can be used to control one or more switching components 208a-c that are used to selectively couple the terminals 108a-c with the power harvesting unit 104. Causing the power harvesting unit 104 to provide the electrical energy to the load devices 110a, 110b can involve actuating these switching components such that electrical paths are provided between the power harvesting unit 104 and the terminals 108a, 108b, as described above with respect to FIG. 2.

In some aspects, the controller 106 can cause the power harvesting unit to provide the electrical energy based on the determined allocation by changing the duty cycles of a current or voltage waveform generated by the power supply system 102. For example, the controller 106 can configure the power harvesting unit 104 to modify a duty cycle of a first alternating current provided to load device 110a in accordance with the determined allocation, and can configure the power harvesting unit 104 to modify a duty cycle of a second alternating current provided to load device 110b in accordance with the determined allocation.

In additional or alternative aspects, the controller 106 can provide commands to the load devices 110a, 110b that control the operation of the load devices 110a, 110b based on an amount of power available from the power harvesting unit 104 or the amount of detected light in a deployment environment. For example, the load devices 110a, 110b may include multiple lighting devices, such as lighting devices of different colors or lighting devices with different intensity levels. The controller 106 can provide commands to the load devices 110a, 110b to activate lighting devices having certain colors or intensity levels based on the amount of power available from the power harvesting unit 104 and/or the amount of detected light in an environment in which the power supply system 102 is deployed.

In additional or alternative aspects, the controller 106 can determine allocations of electrical energy and cause the power harvesting unit 104 to provide the electrical energy based on data from one or more sensors. For example, one or more sensors may be positioned on, in, or near the housing 105, the structure 107, or some other portion of a shelf or product display. The sensors can be communicatively coupled to the controller 106 via one or more wireless communication channels and/or one or more wired connections. In some aspects, the sensors can be powered by the power supply system 102. The controller 106 may receive data from one or more sensors. For example, the data may indicate that an object (e.g., a shopper) is near a display system that is powered using the power supply system 102. The controller 106 can respond to receiving the data by causing energy to be provided to one or more load devices 110a, 110b.

For example, if a consumer picks up a package from a display system, the motion can be detected by a sensor. Data indicative of the motion can be provided from the sensor to the controller 106. The controller 106 can cause energy to be provided to an illuminated sign or other load device, thereby causing the illuminated sign to be illuminated while the consumer is present. In this manner, power consumption by one or more load devices may be limited to time periods in which a consumer is in the vicinity of a display system that is powered using the power supply system 102.

Any suitable sensor can be used with the power supply system 102. Suitable sensors may include low-power sensors having power requirements that involve using a small percentage (e.g., less than 10%) of the energy generated by the power supply system 102. Examples of suitable sensors include capacitance sensors or other touch sensors, motion sensors, etc.

In some aspects, one or more other features of the power supply system 102 may be controlled using sensor inputs. For example, the controller 106 may have a low-power mode of operation in which the controller 106 uses a minimal amount of power required for detecting sensor inputs and a higher-power mode of operation in which the controller 106 uses an amount of power sufficient for performing one or more of the operations depicted in FIG. 4. The controller 106 may switch from the low-power mode to the higher-power mode in response to receiving a sensor input indicative of a consumer being in the vicinity of a display system, as described above. The controller 106 may activate a timer after entering the higher-power mode. If additional sensor inputs are received by the controller 106 prior to the expiration of the timer that indicate that the consumer is in the vicinity of the display system, the controller 106 can restart the timer. If additional sensor inputs are not received by the controller 106 prior to the expiration of the timer (e.g., if the consumer is no longer in the vicinity of the display system), the controller 106 can enter the low-power mode.

Additionally or alternatively, the power supply system 102 can use load identification to prevent unauthorized devices from being powered using the power supply system 102. FIG. 5 is a flow chart depicting an example of a method 500 for preventing electrical energy generated by a power harvesting unit 104 from being provided to an unauthorized load device. For illustrative purposes, the method 500 is described with reference to the implementation depicted in FIGS. 1-3. Other implementations, however, are possible.

The method 500 involves converting light energy into electrical energy using a power harvesting unit 104 of a power supply system, as depicted in block 502. For example, the power harvesting unit 104 can generate electrical energy from light energy as described above with respect to FIGS. 1 and 2.

The method 500 also involves determining that a device that is receiving at least some of the electrical energy is not authorized to receive power from the power supply system, as depicted in block 504. For example, the processing device 302 can execute a power management module 306 or other suitable program code stored in a memory device 304. Executing the power management module 306 or other suitable program code can configure the processing device 302 to perform one or more operations that involve determining that one or more devices that are electrically coupled to the power supply system 102 are not authorized to receive power from the power supply system 102.

In some aspects, the controller 106 can use password queries to determine that one or more devices are not authorized to receive power from the power supply system 102. For example, the controller 106 can periodically query devices that are electrically coupled to the power supply system 102 via the terminals 108a-c. The controller 106 can determine whether one or more of the connected devices are licensed for operation or otherwise authorized for use with the power supply system 102. For instance, the controller 106 can query the load devices 110a, 110b connected to the respective terminals 106a, 108b and can also query the unauthorized device 112 connected to the terminal 108c. The querying process can be sufficiently simple to minimize power requirements for the controller 106.

In some aspects, the query to the device can be a password query included in an encrypted message. A communication link between the controller 106 and the load devices 110a, 110b can utilize any suitable encryption. As an example, electronic communications between the controller 106 and the load devices 110a, 110b may be encrypted using 128-bit Advanced Encryption Standard (“AES”) methods.

In some aspects, the controller 106 can determine whether a device is authorized based on whether the device provides a response that includes a password. In one example, the controller 106 can determine that a load device 112 or a load device 114 is not authorized to receive power from the power supply system 102 based on the device providing a response that does not include the password. In another example, the controller 106 can determine that a load device 112 or a load device 114 is not authorized to receive power from the power supply system 102 based on the device failing to provide any response to the query within a specified time period. For example, the controller 106 can start a timer based on transmitting the password query. If the timer expires before a response to the password query is received from a given device, the controller 106 can determine that the device is not authorized to receive power from the power supply system 102.

In some aspects, the controller 106 can send dummy password queries that authorized devices are configured to ignore and that cause unauthorized devices to temporarily disconnect. For example, response activity from an unauthorized device 112 can generate measurable current variations on an electrical coupling between the terminal 108c and the unauthorized device 112. The controller 106 can detect the current variations. The controller 106 can cause the terminal 108c to be disabled based on detecting the current variations. Either the presence of a corrupted password response, the presence of an unexpected current draw, or other electrical activity indicating that an unauthorized device 112 is attempting to process the dummy password query can allow the controller 106 to detect an unauthorized device 112.

The controller 106 can transmit a query for a dummy password to the load devices 110a, 110b and the device 112 via the respective terminals 108a-c or other suitable communication links. The controller 106 can determine whether responses are received within a specified period. For example, the controller 106 can start a timer based on transmitting the dummy password query. A response may be received from a device before the timer expires, or other activity (e.g., current variations) may occur before the timer's expiration that indicate that the device has not ignored the dummy query. The controller 106 can determine that the device is not authorized to receive power from the power supply system 102 based on the device transmitting a response or based on the other activity indicating that the device has not ignored the dummy password. Additionally or alternatively, if the timer expires without a response to the password query being received from a given device, the controller 106 can determine that the device is authorized to receive power from the power supply system 102. Additionally or alternatively, if the timer expires without other activity occurring that would otherwise indicate that the device is attempting to respond to the query (e.g., current variations on the electrical path to the device), the controller 106 can determine that the device has ignored the dummy password query and is therefore authorized to receive power from the power supply system 102.

In additional or alternative aspects, preventing unauthorized use of the power supply system 102 can include detecting the presence of an unauthorized device 114 attempting to draw power through a vampire-attach on a wire between a terminal and an authorized device (e.g., the wire between the terminal 108b and the load device 110b in FIG. 1). The presence of the unauthorized device 114 can change the impedance or other electrical characteristics of the electrical coupling, even if the unauthorized device 114 attempts to circumvent the security protocols implemented by the controller 106. In one example, during the response period of a password query, the impedance of the wire between the terminal 108b and the load device 110b may be increased. If an unauthorized device 114 is attempting to draw power during the response period, the response message will be corrupted.

The controller 106 can detect the presence of the unauthorized device 114 by periodically testing the impedance of an electrical coupling between one or more components of the power supply system 102 and the unauthorized device 114. The controller 106 can identify or otherwise determine a first impedance associated with an electrical coupling between the power supply system 102 and an authorized load device (e.g., the impedance of a wire electrically connecting the power harvesting unit 104 to one of the terminals 108a-c). The controller 106 can subsequently identify or otherwise determine a second impedance associated with the electrical coupling. The controller 106 can determine, based on a difference between the first impedance and the second impedance, that at least one device that is not authorized to receive power is electrically coupled to the power supply system 102.

In some aspects, the periodic testing of the wires can be performed in a randomized manner. For example, the controller 106 can terminate power to the terminals 108a-c according to random points in time and/or for randomized amounts of time. Randomizing the testing can prevent unauthorized parties from predicting when the testing occurs by identifying historical time periods in which testing occurred.

The method 500 also involves preventing the power harvesting unit 104 from providing the electrical energy to the unauthorized device, as depicted in block 506. For example, the processing device 302 can execute a power management module 306 or other suitable program code stored in a memory device 304. Executing the power management module 306 or other suitable program code can configure the processing device 302 to perform one or more operations that involve preventing the power harvesting unit 104 from providing the electrical energy to the unauthorized device. If the device is one of the authorized load devices 110a, 110b, the controller 106 can configure the power harvesting unit 104 to supply power to a terminal via which the device is coupled to the power supply system 102 (e.g., the terminals 108a, 108b). If the device is one of the unauthorized devices 112, 114, the controller 106 can disable (or cause to be disabled) a terminal 108c to which the unauthorized device 112 is connected.

In some aspects, the controller 106 can operate one or more switching components 208a-c that are used to selectively couple the terminals 108a-c with the power harvesting unit 104. Preventing the power harvesting unit 104 from providing the electrical energy to the unauthorized device can involve actuating these switching components 208a-c such that an electrical path does not allow electrical current to flow between the power harvesting unit 104 and a terminal that is electrically coupled to the unauthorized device.

In some aspects, the operations described with respect to FIGS. 4 and 5 can be combined. For example, the power supply system 102 may perform one or more of the operations described above with respect to FIG. 5 based on determining an amount of power available from the power harvesting unit 104, the power requirements of the authorized load devices 110a, 110b, or one or more other criteria described above with respect to FIG. 4.

The foregoing description of aspects and features of the disclosure, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of this disclosure. Aspects and features from each example disclosed can be combined with any other example. The illustrative examples described above are given to introduce the reader to the general subject matter discussed here and are not intended to limit the scope of the disclosed concepts.

The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. The terms “invention,” “the invention,” “this invention” and “the present invention” used in this disclosure are intended to refer broadly to all of the subject matter of this disclosure and the patent claims below. Statements containing these terms should be understood not to limit the subject matter described herein or to limit the meaning or scope of the patent claims below.

1. A power supply system comprising:
a power harvesting unit configured to convert light energy into electrical energy;
at least one terminal electrically coupled to the power harvesting unit, wherein the at least one terminal is configured for providing the electrical energy to at least one device; and
a controller communicatively coupled to the at least one terminal, wherein the controller is configured for:
determining that the at least one device that is receiving power via the at least one terminal is not authorized to receive power from the power supply system, and
preventing the power harvesting unit from providing the electrical energy to the at least one device.

2. The power supply system of claim 1, wherein the controller is configured for determining that the at least one device is not authorized to receive power from the power supply system by performing operations comprising:
transmitting an encrypted query for a password to the at least one device; and
determining that the at least one device has failed to provide a response that includes the password.

3. The power supply system of claim 1, wherein the controller is configured for determining that the at least one device is not authorized to receive power from the power supply system by performing operations comprising:
transmitting a query for a dummy password to the at least one device via the at least one terminal and to at least one additional device via at least one additional terminal of the power supply system; and
determining that the at least one device responded to the query for the dummy password within a time period;
wherein the controller is further configured for determining that the at least one additional device is authorized to receive power from the power supply system based on determining that the at least one device has not responded to the query for the dummy password within the time period.

4. The power supply system of claim 3, wherein the controller is configured for determining that the at least one device responded to the query for the dummy password within a time period by performing operations comprising:
monitoring an electrical current flowing through an electrical coupling from the at least one terminal to the at least one device;
identifying a change in the monitored electrical current within the time period and subsequent to transmitting the query for the dummy password, wherein the change in the monitored electrical current is indicative of the at least one device processing the query for the dummy password.

5. The power supply system of claim 1, wherein the controller is configured for determining that the at least one device is not authorized to receive power from the power supply system by performing operations comprising:
determining, during a first time period, a first impedance associated with an electrical coupling with an authorized device via the at least one terminal;
determining, during a second time period, a second impedance associated with the electrical coupling including the at least one terminal; and
determining, based on a difference between the first impedance and the second impedance, that the at least one device that is not authorized to receive power is electrically coupled to the power supply system via the at least one terminal.

6. The power supply system of claim 5, wherein the controller is configured for randomly selecting the first time period and the second time period.

7. The power supply system of claim 1, wherein the at least one terminal comprises a first terminal and a second terminal, wherein the controller is further configured for:
determining a maximum amount of electrical energy available from the power harvesting unit;
identifying a first power requirement for a first device that is electrically coupled to the power supply system via the first terminal;
identifying a second power requirement for a second device that is electrically coupled to the power supply system via the second terminal;
determining an allocation of the electrical energy between the first device and the second device based on the first power requirement, the second power requirement, and the maximum amount of electrical energy available from the power harvesting unit; and
causing the power harvesting unit to provide the electrical energy to the first device and the second device based on the determined allocation.

8. A display system comprising:
a first illumination device;
a second illumination device; and
a power supply system comprising:
a power harvesting unit configured to convert light energy into electrical energy,
a first terminal electrically coupling the power harvesting unit to the first illumination device,
a second terminal electrically coupling the power harvesting unit to the second illumination device, and
a controller communicatively coupled to the first terminal and the second terminal, wherein the controller is configured for:
determining a maximum amount of electrical energy available from the power harvesting unit;
identifying a first power requirement for the first illumination device and a second power requirement for the second illumination device;
determining an allocation of the electrical energy between the first illumination device and the second illumination device based on the first power requirement, the second power requirement, and the maximum amount of electrical energy available from the power harvesting unit; and
causing the power harvesting unit to provide, based on the determined allocation, the electrical energy to the first illumination device via the first terminal and the second illumination device via the second terminal.

9. The display system of claim 8, wherein the controller is configured for determining the allocation of the electrical energy by performing operations comprising:
determining a combined power requirement of the first illumination device and the first illumination device;
allocating a first portion of the electrical energy to the first illumination device, wherein the first portion is proportionate to a first contribution of the first power requirement to the combined power requirement; and
allocating a second portion of the electrical energy to the second illumination device, wherein the second portion is proportionate to a second contribution of the second power requirement to the combined power requirement.

10. The display system of claim 8, wherein the controller is configured for determining the allocation of the electrical energy by performing operations comprising:
identifying a minimum number of activations for at least one of the first illumination device and the second illumination device, a first priority for the first illumination device, and a second priority for the second illumination device;
allocating a portion of the electrical energy such that the at least one of the first illumination device and the second illumination device is activated in accordance with the minimum number of activations;
allocating a first additional portion of the electrical energy to the first illumination device based on the first priority; and
allocating a second additional portion of the electrical energy to the second illumination device based on the second priority.

11. The display system of claim 8, wherein the controller is configured for determining the maximum amount of electrical energy available from the power harvesting unit by performing operations based on an amount of light energy detected by the power harvesting unit.

12. The display system of claim 8, wherein the controller is configured for causing the power harvesting unit to provide the electrical energy based on the determined allocation by configuring the power harvesting unit to modify a first duty cycle of a first alternating current provided to the first illumination device via the first terminal in accordance with the determined allocation and to modify a second duty cycle of a second alternating current provided to the second illumination device via the second terminal in accordance with the determined allocation.

13. The display system of claim 8, wherein at least one of the first illumination device and the second illumination device comprises a plurality of lighting devices, wherein the controller is further configured for transmitting, based on determining that the maximum amount of electrical energy is less than a threshold amount of electrical energy, a command to the at least one of the first illumination device and the second illumination device to deactivate a subset of the plurality of lighting devices.

14. The display system of claim 8, wherein the controller is further configured for:
determining that at least one device that is receiving power via at least one terminal of the power supply system is not authorized to receive power from the power supply system, and
preventing the power harvesting unit from providing the electrical energy to the at least one device.

15. A method comprising:
determining a maximum amount of electrical energy available from a power harvesting unit that generates electrical energy from light energy;
identifying a first power requirement for a first illumination device that is electrically coupled to the power harvesting unit;
identifying a second power requirement for a second illumination device that is electrically coupled to the power harvesting unit;
determining an allocation of the electrical energy between the first illumination device and the second illumination device based on the first power requirement, the second power requirement, and the maximum amount of electrical energy available from the power harvesting unit; and
causing the power harvesting unit to provide the electrical energy to the first illumination device and the second illumination device in accordance with the determined allocation.

16. The method of claim 15, wherein determining the allocation of the electrical energy comprises:
determining a combined power requirement of the first illumination device and the second illumination device;
allocating a first portion of the electrical energy to the first illumination device, wherein the first portion is proportionate to a first contribution of the first power requirement to the combined power requirement; and
allocating a second portion of the electrical energy to the second illumination device, wherein the second portion is proportionate to a second contribution of the second power requirement to the combined power requirement.

17. The method of claim 15, wherein determining the allocation of the electrical energy comprises:
identifying a minimum number of activations for at least one of the first illumination device and the second illumination device, a first priority for the first illumination device, and a second priority for the second illumination device;
allocating a portion of the electrical energy such that the at least one of the first illumination device and the second illumination device is activated in accordance with the minimum number of activations;
allocating a first additional portion of the electrical energy to the first illumination device based on the first priority; and
allocating a second additional portion of the electrical energy to the second illumination device based on the second priority.

18. The method of claim 15, wherein configuring the power harvesting unit to provide the electrical energy in accordance with the determined allocation comprises:
configuring the power harvesting unit to modify a first duty cycle of a first alternating current provided to the first illumination device via the first terminal in accordance with the determined allocation; and
configuring the power harvesting unit to modify a second duty cycle of a second alternating current provided to the second illumination device via the second terminal in accordance with the determined allocation.

19. The method of claim 15, wherein at least one of the first illumination device and the second illumination device comprises a plurality of lighting devices, wherein the method further comprises transmitting, based on determining that the maximum amount of electrical energy is less than a threshold amount of electrical energy, a command to the at least one of the first illumination device and the second illumination device to deactivate a subset of the plurality of lighting devices.

20. The method of claim 15, further comprising:
determining that at least one device that receives at least some of the electrical energy via at least one terminal is not authorized to receive the electrical energy, and
preventing the power harvesting unit from providing the electrical energy to the at least one device.

21. The method of claim 15, further comprising:
receiving data from a sensor; and
determining that the received data indicates a presence of at least one person in an area in which at least one of the first and second illumination devices is positioned, wherein the allocation of the electrical energy between the first illumination device and the second illumination device is also based on determining the presence of the at least one person.
